(19) United States
(12) Patent Application Publication
(10) Pub. No.: US 2025/0367809 A1
(43) Pub. Date: Dec. 4, 2025

(54) BATTERY-POWERED CHAINSAW OR BATTERY-POWERED ANGLE GRINDER AND HANDHELD BATTERY-POWERED WORK APPARATUS

(71) Applicant: Andreas Stihl AG & Co. KG, Waiblingen (DE)

(72) Inventors: Marcel Förster, Schwaikheim (DE); Roland Mandel, Stuttgart (DE); Martin Failenschmid, Engstingen (DE)

(21) Appl. No.: 19/227,176

(22) Filed: Jun. 3, 2025

(30) Foreign Application Priority Data
Jun. 3, 2024 (DE) 10 2024 115 402.0

(51) Int. Cl. B25F 5/02; B24B 23/02; B27B 17/00; B27B 17/08

(52) U.S. Cl. CPC B25F 5/02; B24B 23/028; B27B 17/0008; B27B 17/08

(57) ABSTRACT

A battery-powered chainsaw or angle grinder includes a housing, a motor, a tool drivable by the motor within a movement plane, a rear handle, and two battery receptacles. The tool is arranged at the front housing end. A lateral direction runs at right angles to the movement plane. The two battery receptacles lie next to each other in the lateral direction and enclose between them a center point. The center point lies, measured in the lateral direction, with a lateral center-point spacing from the movement plane of the tool. The rear handle lies, measured in the lateral direction, with a lateral handle spacing from the movement plane. The lateral handle spacing is greater than the lateral center-point spacing. A notional center axis runs between receptacles and the actuating parts of battery locks are arranged offset with respect to each other in the direction of the center axis.

### CROSS-REFERENCE TO RELATED APPLICATIONS

This application claims priority of German patent application no. 10 2024 115 402.0, filed Jun. 3, 2024, the entire content of which is incorporated herein by reference.

### TECHNICAL FIELD

The disclosure relates to a battery-powered chainsaw or to a battery-powered angle grinder.

### BACKGROUND

Chainsaws or angle grinders have a work tool which can be driven within a movement plane by its drive motor. A chainsaw is a saw chain circulating around a guide bar, and an angle grinder is a cutting or grinding disk driven in rotation within a plane of rotation. The apparatuses are guided manually by the user, wherein during operation the primary objective is guidance within the movement plane. To do this, corresponding forces and torques need to be applied by the user in particular at the rear handle. The objective is a well-balanced structure for energy-saving and precise guidance of the apparatuses.

In battery-powered apparatuses, the weight of the battery packs used plays an important role. This is true in particular for battery-powered chainsaws or battery-powered angle grinders of a high power class which are widely provided with two battery receptacles for receiving in each case one battery pack in order to supply a sufficient amount of energy. In order to avoid too long a structural form, the two battery receptacles are arranged next to one another in the lateral direction. Lying laterally between them is a battery receptacle center point which, when two identical battery packs are inserted, approximately coincides with their common center of gravity. Because the two battery receptacles lie next to one another in the lateral direction and thus occupy a significant width, their battery receptacle center point lies far away in the lateral direction from the movement plane of the work tool. The common center of gravity of the two battery packs consequently lies laterally next to the work tool with a large lever arm. The torque about the longitudinal axis, generated by the weight force of the battery packs and the lever arm, must be compensated by the user by manual force in particular at the rear handle. The apparatus tends to tilt during operation, which adversely affects the accuracy of the cut to be made, and which moreover is exhausting.

The battery packs inserted into the battery receptacles have to be secured against falling out by a suitable removable locking mechanism. If such battery locks are positioned between the two battery receptacles so that they can be reached easily, they require a corresponding structural space which increases the lateral spacing between the battery receptacles or between the inserted battery packs. The eccentricity of the battery receptacle center point and the above-described difficulties resulting therefrom are thus also increased. This is especially true given the fact that space has to be made available for the user to intervene with at least one finger in addition to the space at the side for the two battery locks.

### SUMMARY

It is an object of the disclosure is to develop a battery-powered chainsaw or a battery-powered angle grinder in such a way that the balance is improved.

This object is achieved by a battery-powered chainsaw or a battery-powered angle grinder including a housing, a drive motor, a work tool which can be driven by the drive motor within a movement plane, and two battery receptacles for receiving in each case one battery pack for supplying the drive motor with electrical energy, wherein the work tool is arranged at a front end of the housing, wherein a rear handle is arranged at a rear end of the housing, wherein a lateral direction runs at right angles to the movement plane of the work tool, wherein the two battery receptacles lie next to each other in the lateral direction and enclose between them a battery receptacle center point, wherein the battery receptacle center point lies, measured in the lateral direction, with a lateral center-point spacing from the movement plane of the work tool, and wherein the rear handle lies, measured in the lateral direction, with a lateral handle spacing from the movement plane of the work tool, wherein the lateral handle spacing is greater than the lateral center-point spacing.

The battery receptacle center point lies, measured in the lateral direction, with a lateral center-point spacing from the movement plane of the work tool. The rear handle lies, measured in the lateral direction, with a lateral handle spacing from the movement plane of the work tool. According to the disclosure, it is provided that the lateral handle spacing is greater than the lateral center-point spacing. The lateral handle spacing is advantageously at least 5% and in particular at least 10% greater than the lateral center-point spacing. In other words, the battery receptacle center point lies, measured in the lateral direction, between the rear handle and the movement plane of the work tool. The common center of gravity of the two battery packs thus generates, during normal operation, a weight force torque about the lower line of engagement of the work tool, the weight force torque being lower than if it had the same or a larger spacing as or than the lateral handle spacing. A lower counter-torque consequently has to be applied at the rear handle of the battery-powered chainsaw or the battery-powered angle grinder.

The battery-powered chainsaw or the battery-powered angle grinder have a net center of gravity when no battery packs are inserted and a gross center of gravity when the battery packs are inserted, wherein these two centers of gravity lie in the lateral direction with a first lateral center-of-gravity spacing or with a second lateral center-of-gravity spacing from the movement plane of the work tool. In particular, the lateral handle spacing is at least 1.25 times and in particular at least 1.5 times the first lateral center-of-gravity spacing of the net center of gravity. In particular, in another aspect the lateral handle spacing is at least 1.15 times and in particular at least 1.3 times the second lateral center-of-gravity spacing of the gross center of gravity. These geometric parameters also contribute to improving the balance of the apparatus.

In an embodiment, the battery-powered chainsaw or the battery-powered angle grinder has a front bale handle with a lateral handle section, wherein the rear handle lies, measured in the lateral direction, between the battery receptacle center point and the lateral handle section. In the case of tasks or sawing or cutting which are performed horizontally, the rear handle lies higher than in the prior art and with only a small height difference from the lateral handle section. The user can take hold of, carry, and guide the apparatus with both hands at almost the same height, as a result of which the balance of the apparatus is also improved in this use case.

The battery receptacles have a notional central plane between them. The battery receptacles moreover have in each case an electrical contact for electrically connecting the respective battery pack to the battery-powered chainsaw or the battery-powered angle grinder. In an embodiment, a first contact spacing of the first electrical contact of the first battery receptacle from the notional central plane and a second contact spacing of the second electrical contact of the second battery receptacle from the notional central plane are not the same. The battery packs have in each case at least one HMI element (HMI=human-machine interface). In a further embodiment, the battery receptacles are configured in such a way that, in the inserted state of the battery packs, a first element spacing of the first HMI element of the first battery pack from the notional central plane and a second element spacing of the corresponding second HMI element of the second battery pack from the notional central plane are not the same. This contributes to improving the user-friendliness because battery packs can be inserted next to one another into the corresponding battery receptacles in the same direction without being rotated.

In a further aspect according to the disclosure, the two battery receptacles are arranged adjacent to each other, wherein two associated battery locks are positioned between the two battery receptacles. Each battery lock has a locking part and an actuating part. A notional center axis runs between the battery receptacles. The actuating parts of the battery locks are arranged offset with respect to each other in the direction of the center axis. As a result, the two actuating parts do not cover each other. Manual actuation of the two actuating parts independently of each other is possible comfortably even in the case of very little lateral structural space. Despite the interposed battery locks, the battery receptacles can be positioned with a small lateral spacing from each other, as a result of which the battery-powered work apparatus is narrower and as a result of which the center of gravity of the apparatus moves closer to the work tool, which improves the balance of the battery-powered work apparatus.

The battery receptacles are advantageously arranged so that they are situated opposite each other, that is, with no offset between them in the longitudinal direction, with respect to the center axis. A compact structure in the longitudinal direction consequently results.

In an embodiment, the locking parts are arranged centrally with respect to the respective associated battery receptacle in the direction of the center axis. As a result, the inserted battery packs are retained centrally, which avoids tilting under load.

In an embodiment, the actuating parts of the battery locks are arranged in each case offset with respect to the associated locking parts in the direction of the center axis. In particular, the battery receptacles are situated opposite each other in a lateral direction at right angles to the center axis, wherein the two battery locks are configured as identical parts and are arranged point symmetrically relative to each other with respect to an axis of symmetry lying at right angles to the center axis and to the lateral direction. An overall compact structure results with the actuating parts being easily reachable independently of each other.

The battery locks can be configured as slides, push buttons, or the like. In particular, the battery locks are configured as pivotable locking levers with pivot axes running parallel to the center axis. A robust and hard-wearing structure with a low space requirement results.

In an embodiment, the actuating parts of the two battery locks have in each case first actuating sections and second actuating sections and are arranged in such a way that the respective first actuating sections of the two actuating parts are situated opposite each other with respect to the center axis, and that no part of the in each case other actuating part is situated opposite the second actuating sections of the two actuating parts with respect to the center axis. As a result, two actuating options are combined. On the one hand, actuation of the battery locks at the second actuating sections independently of each other is possible. On the other hand, joint actuation of the two battery locks at the first actuating sections situated directly opposite each other can be performed with just one movement of the hand or one press of a finger in order to unlock the two battery packs together.

In an embodiment, the two battery receptacles are configured to receive the two battery packs in the same rotated position. As a result, despite the central positioning of the battery locks between the battery receptacles, the user does not have to find different rotated positions of the two battery packs and instead can insert them intuitively with the same side.

It is a further object of the disclosure to provide a handheld battery-powered work apparatus such that the lateral space requirement is reduced with good user comfort.

This object is, for example, achieved by a handheld work apparatus including a housing, a drive motor, a work tool which can be driven by the drive motor, two battery receptacles for receiving in each case one battery pack for supplying the drive motor with electrical energy, and two battery locks, wherein each battery receptacle is associated in each case with a battery lock for locking a battery pack inserted in each case, wherein the two battery receptacles are arranged adjacent to each other, and wherein the two battery locks are positioned between the two battery receptacles, and wherein each battery lock has a locking part and an actuating part, wherein a notional center axis runs between the battery receptacles, and wherein the actuating parts of the battery locks are arranged offset with respect to each other in the direction of the center axis.

It is provided that the two battery receptacles are arranged adjacent to each other, wherein the two battery locks are positioned between the two battery receptacles. Each battery lock has a locking part and an actuating part. A notional center axis runs between the battery receptacles. The actuating parts of the battery locks are arranged offset with respect to each other in the direction of the center axis. As a result, the two actuating parts do not cover each other. Manual actuation of the two actuating parts independently of each other is possible comfortably even in the case of very little lateral structural space. Despite the interposed battery locks, the battery receptacles can be positioned with a small lateral spacing from each other, as a result of which the battery-powered work apparatus is narrower and as a result of which the center of gravity of the apparatus moves closer to the work tool, which improves the balance of the battery-powered work apparatus.

The battery receptacles are advantageously arranged so that they are situated opposite each other, that is, with no offset between them in the longitudinal direction, with respect to the center axis. A compact structure in the longitudinal direction consequently results.

In an embodiment, the locking parts are arranged centrally with respect to the respective associated battery receptacle in the direction of the center axis. As a result, the inserted battery packs are retained centrally, which avoids tilting under load.

In an embodiment, the actuating parts of the battery locks are arranged in each case offset with respect to the associated locking parts in the direction of the center axis. In particular, the battery receptacles are situated opposite each other in a lateral direction at right angles to the center axis, wherein the two battery locks are configured as identical parts and are arranged point symmetrically relative to each other with respect to an axis of symmetry lying at right angles to the center axis and to the lateral direction. An overall compact structure results with the actuating parts being easily reachable independently of each other.

The battery locks can be configured as slides, push buttons, or the like. In particular, the battery locks are configured as pivotable locking levers with pivot axes running parallel to the center axis. A robust and hard-wearing structure with a low space requirement results.

In an embodiment, the actuating parts of the two battery locks have in each case first actuating sections and second actuating sections and are arranged in such a way that the respective first actuating sections of the two actuating parts are situated opposite each other with respect to the center axis, and that no part of the in each case other actuating part is situated opposite the second actuating sections of the two actuating parts with respect to the center axis. As a result, two actuating options are combined. On the one hand, actuation of the battery locks at the second actuating sections independently of each other is possible. On the other hand, joint actuation of the two battery locks at the first actuating sections situated directly opposite each other can be performed with just one movement of the hand or one press of a finger in order to unlock the two battery packs together.

In an embodiment, the two battery receptacles are configured to receive the two battery packs in the same rotated position. As a result, despite the central positioning of the battery locks between the battery receptacles, the user does not have to find different rotated positions of the two battery packs and instead can insert them intuitively with the same side.

In a further aspect according to the disclosure, the work tool is arranged at a front end of the housing, wherein a rear handle is arranged at a rear end of the housing. A lateral direction runs at right angles to the movement plane of the work tool, wherein the two battery receptacles lie next to each other in the lateral direction and enclose between them a battery receptacle center point. The battery receptacle center point lies, measured in the lateral direction, with a lateral center-point spacing from the movement plane of the work tool. The rear handle lies, measured in the lateral direction, with a lateral handle spacing from the movement plane of the work tool. According to the disclosure, it is provided that the lateral handle spacing is greater than the lateral center-point spacing. The lateral handle spacing is advantageously at least 5% and in particular at least 10% greater than the lateral center-point spacing. In other words, the battery receptacle center point lies, measured in the lateral direction, between the rear handle and the movement plane of the work tool. The common center of gravity of the two battery packs thus generates, during normal operation, a weight force torque about the lower line of engagement of the work tool, the weight force torque being lower than if it had the same or a larger spacing as or than the lateral handle spacing. A lower counter-torque consequently has to be applied at the rear handle of the battery-powered chainsaw or the battery-powered angle grinder.

The battery-powered chainsaw or the battery-powered angle grinder have a net center of gravity when no battery packs are inserted and a gross center of gravity when the battery packs are inserted, wherein these two centers of gravity lie in the lateral direction with a first lateral center-of-gravity spacing or with a second lateral center-of-gravity spacing from the movement plane of the work tool. In particular, the lateral handle spacing is at least 1.25 times and in particular at least 1.5 times the first lateral center-of-gravity spacing of the net center of gravity. In particular, in another aspect the lateral handle spacing is at least 1.15 times and in particular at least 1.3 times the second lateral center-of-gravity spacing of the gross center of gravity. These geometric parameters also contribute to improving the balance of the apparatus.

In an embodiment, the battery-powered chainsaw or the battery-powered angle grinder has a front bale handle with a lateral handle section, wherein the rear handle lies, measured in the lateral direction, between the battery receptacle center point and the lateral handle section. In the case of tasks or sawing or cutting which are performed horizontally, the rear handle lies higher than in the prior art and with only a small height difference from the lateral handle section. The user can take hold of, carry, and guide the apparatus with both hands at almost the same height, as a result of which the balance of the apparatus is also improved in this use case.

The battery receptacles have a notional central plane between them. The battery receptacles moreover have in each case an electrical contact for electrically connecting the respective battery pack to the battery-powered chainsaw or the battery-powered angle grinder. In an embodiment, a first contact spacing of the first electrical contact of the first battery receptacle from the notional central plane and a second contact spacing of the second electrical contact of the second battery receptacle from the notional central plane are not the same. The battery packs have in each case at least one HMI element (HMI=human-machine interface). In a further embodiment, the battery receptacles are configured in such a way that, in the inserted state of the battery packs, a first element spacing of the first HMI element of the first battery pack from the notional central plane and a second element spacing of the corresponding second HMI element of the second battery pack from the notional central plane are not the same. This contributes to improving the user-friendliness because battery packs can be inserted next to one another into the corresponding battery receptacles in the same direction without being rotated.

### BRIEF DESCRIPTION OF DRAWINGS

The invention will now be described with reference to the drawings wherein: FIG. 1 shows a perspective view of a battery-powered chainsaw with a guide bar arranged thereon, with a rear handle, and with two battery packs arranged next to each other;

FIG. 2 shows a plan view from above of the battery-powered chainsaw according to FIG. 1 with details of the lateral positioning of the rear handle and the two battery receptacles;

FIG. 3 shows an enlarged detailed illustration of the battery area of the battery-powered chainsaw according to FIG. 1 with details of the lateral positioning of HMI elements of the inserted battery packs;

FIG. 4 shows a rear view of individual components of the two battery receptacles of the battery-powered chainsaw according to FIGS. 1 to 3 with details of the lateral positioning of electrical contacts;

FIG. 5 shows an enlarged plan view of the battery area of the battery-powered chainsaw according to FIG. 1 with details of the point-symmetrical arrangement of two battery locks; and,

FIG. 6 shows a side view of a battery pack and a battery lock engaging therewith and illustrated as a detached individual part.

### DETAILED DESCRIPTION

FIG. 1 shows a perspective view of a handheld work apparatus according to the disclosure in the example of a battery-powered chainsaw. It can, however, also be a battery-powered angle grinder within the scope of the disclosure. Other portable battery-powered work apparatuses can also be considered within the scope of the disclosure. The battery-powered chainsaw includes a housing 1 in which an electric drive motor M (indicated only schematically) for driving a work tool 2 is arranged. The drive motor M is fed with electrical energy via two battery packs 8, 9.

As illustrated in FIG. 1, the housing 1 extends in a longitudinal direction x from a rear end 15 to a front end 14. The work tool 2 is arranged at the front end 14 of the housing 1 and can be driven by the drive motor M so that it circulates within a movement plane E_{B}. In the embodiment shown, the work tool 2 is configured as a saw chain 16 which is driven during operation via a drive element of the drive motor M so that it circulates around a guide bar 17.

The plane guide bar 17 specifies, by virtue of its plane form, the movement plane E_{B} of the work tool 2. The movement plane E_{B} lies parallel to the longitudinal direction x and moreover specifies a lateral direction y and a vertical direction z. The vertical direction z, like the longitudinal direction x, lies parallel to the movement plane E_{B}, wherein the vertical direction z lies at right angles to the longitudinal direction x. The lateral direction y lies at right angles to the movement plane E_{B}, that is, at right angles to both the longitudinal direction x and the vertical direction z.

The guide bar 17 is arranged, together with the work tool 2 configured as a saw chain 16, at the front end 14 of the housing 1. It extends from the front end 14 in a direction pointing away from the rear end 15. The guide bar 17 thus projects beyond the housing 1 at the front end 14. The work tool 2 is moreover, together with the guide bar 17, arranged close to a side face of the housing 1, off-center with respect to the lateral direction y.

It can furthermore be seen in FIG. 1 that the battery-powered chainsaw includes a rear handle 3 and a front bale handle 4 for guiding and carrying the portable battery-powered chainsaw. The term “portable” means within the sense of this application that the battery-powered chainsaw is carried during proper operation. A hand guard 19 is mounted in front of the front bale handle 4. The hand guard 19 is fixed pivotably on the housing 1 and serves as a trigger for a braking device (not illustrated in detail) acting on the work tool 2.

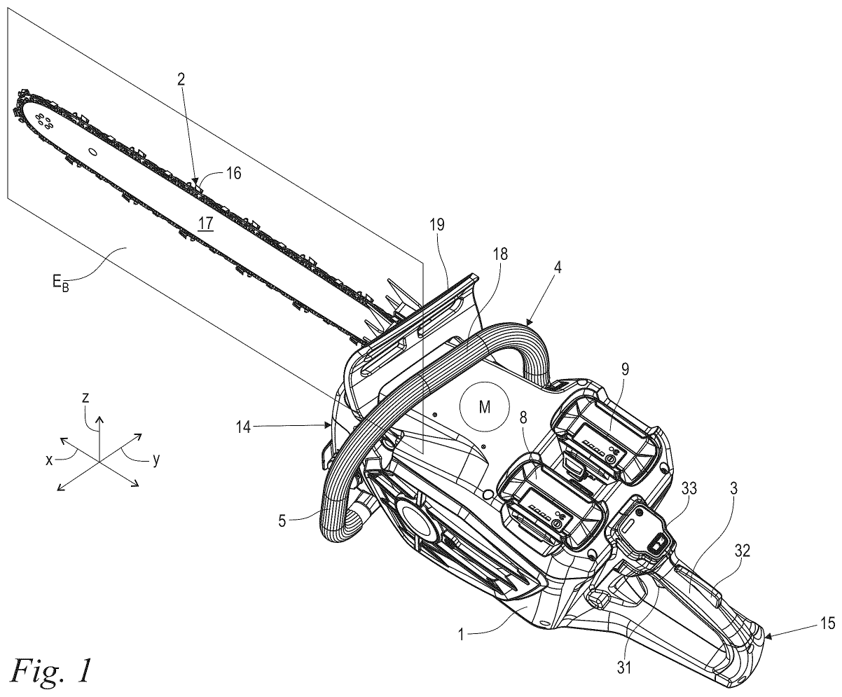

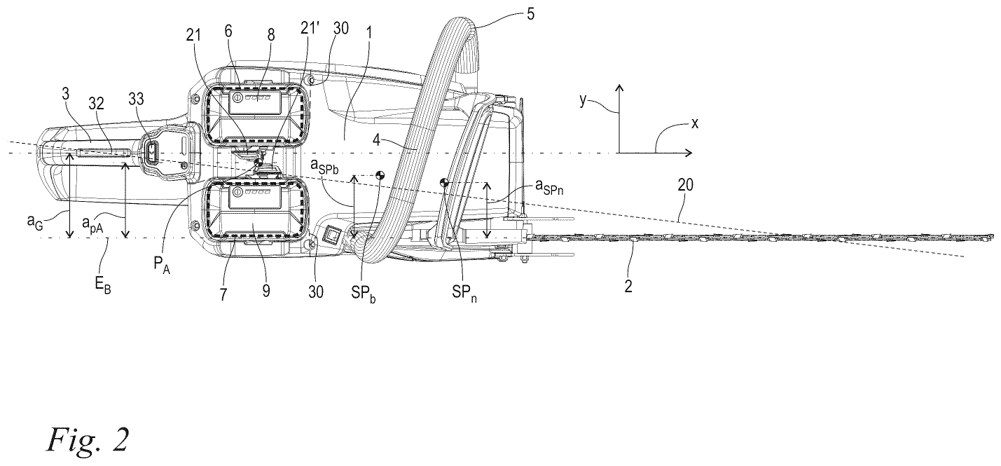

The rear handle 3 is formed on the housing 1. In other words, the rear handle 3 forms the rear end 15 of the housing 1. The two battery packs 8, 9 and the associated battery receptacles 6, 7 (FIGS. 2 and 4 to 6) for the battery packs 8, 9 are disposed in front of the rear handle 3 with respect to the longitudinal direction x. In other words, the rear handle 3 is arranged behind the two battery packs 8, 9 and the associated battery receptacles 6, 7 in relation to the longitudinal direction x. The front bale handle 4 is arranged in front of the rear handle 3 and also in front of the two battery packs 8, 9 and the corresponding battery holders 6, 7 in the longitudinal direction x and surrounds the housing 1 from one longitudinal side, over the top side and as far as the other longitudinal side of the housing 1. The front bale handle 4 has an upper handle section 18 lying above the housing 1 in the vertical direction z. It moreover has a lateral handle section 5 lying to the side of the housing 1 in the lateral direction y and which is situated on the side situated opposite the work tool 2.

One or more, here three, operating elements are arranged on the rear handle 3 or in its immediate vicinity such that they are within reach of a user's hand when this hand grasps the rear handle 3. Relative to the vertical direction z, a first operating element 31 is arranged on the underside of the rear handle 3. This first operating element 31 functions as a switching element for switching the drive motor M on and off, and optionally also for adjusting its speed. The first operating element 31 in the form of a switching element can be a push button or the like and is configured as a pivot lever in the exemplary embodiment. This pivot lever is also colloquially referred to as a “throttle lever.”

Related to the vertical direction z, a second operating element 32 is arranged on the upper side of the rear handle 3. This second operating element 32 functions as a locking element to prevent the drive motor M from starting accidentally. The locking element and the switching element interact such that the drive motor M can only be started via the switching element when the locking element is actuated. The second operating element 32 in the form of the locking element can also be a push button or the like and is configured as a pivoting lever in the exemplary embodiment.

An HMI (Human-Machine Interface) is arranged adjacent to the front end of the rear handle 3, but behind the two battery packs 8, 9 and the associated battery receptacles 6, 7 in the longitudinal direction x. On its upper side, that is, at the top in the vertical direction z, is the third operating element 33, which functions as a mode selection element for selecting the operating mode of the work apparatus. The third operating element 33 in the form of the mode selection element is configured here as a push button, but can also have any other configurations.

The above-described configuration of a battery-powered chainsaw and also the details thereof according to the disclosure and described below applies analogously in the same fashion also for the alternative form, provided within the scope of the disclosure, as a battery-powered angle grinder, wherein the work tool 2 is then configured as a cutting or grinding disk which can be driven in a circulating and rotating fashion, and wherein their plane of rotation specifies the movement plane E_{B}.

FIG. 2 shows a plan view from above of the battery-powered chainsaw according to FIG. 1. The two battery packs 8, 9 are inserted from above into in each case one associated slot-shaped battery receptacle 6, 7 (indicated here only schematically) and are locked via battery locks 21, 21′ described in detail below. The two battery receptacles 6, 7 lie next to each other in the lateral direction y and enclose between them a battery receptacle center point P_{A}. The battery receptacle center point P_{A} is, measured in the lateral direction y and here also measured in the longitudinal direction x, the common geometric center point of the two battery receptacles 6, 7. The battery receptacle center point P_{A} lies, measured in the lateral direction y, with a lateral center-point spacing a_{PA} from the movement plane E_{B} of the work tool 2.

In the embodiment, the battery receptacles 6, 7 are configured as slots which are open on one side, and in the embodiment as slots which are open at the top in the vertical direction z. Alternatively, the battery receptacles 6, 7 can also be open on other and/or on further sides. In particular, at least one battery receptacle 6, 7 can be open at least on one longitudinal side of the battery-powered chainsaw, that is, in the lateral direction y. In particular, at least one battery receptacle 6, 7 can be formed by a guide into which a corresponding mating guide of the battery pack 8, 9 can be pushed. In this case, the battery receptacle 6, 7 is not configured as closed all around the battery pack 8, 9 and instead is also open on peripheral sides of the battery pack 8, 9. In particular, at least one battery receptacle 6, 7 is open at the front and/or the rear at least partially in the longitudinal direction x. One possible alternative configuration of the battery receptacles 6, 7 is marked by dashed lines 30 in FIG. 2.

The rear handle 3 extends along a handle axis which runs in a direction spanned by the longitudinal direction x and the vertical direction z. The rear handle 3, or more precisely the handle axis of the rear handle 3, here lies, measured in the lateral direction y, with a lateral handle spacing a_{G} from the movement plane E_{B} of the work tool. The aforementioned also applies equally to the operating elements 31, 32, 33 already mentioned in connection with FIG. 1, as well as their actuation directions. In other words, the operating elements 31, 32, 33 are located on the plane already mentioned, which includes the handle axis, which is spanned by the longitudinal direction x and the vertical direction z, and which is located at the lateral handle distance a_{G} from the movement plane E_{B} of the tool. The actuation directions of the operating elements 31, 32, 33 for swivel and push actuation lie in the same plane. It can be seen in particular in the plan view according to FIG. 2 that the lateral handle spacing a_{G} is greater than the lateral center-point spacing a_{PA}. In particular, the lateral handle spacing a_{G} is at least 5% and in particular at least 10% greater than the lateral center-point spacing a_{PA}. In the embodiment shown, the lateral handle spacing a_{G} is approximately 13.6% greater than the lateral center-point spacing a_{PA}.

The battery-powered chainsaw furthermore has two relevant charging states, namely with and without battery packs 8, 9 inserted into the battery receptacles 6, 7. If the battery packs 8, 9 are not placed inside or inserted into the battery receptacles 6, 7, the battery-powered chainsaw has a net center of gravity SPₙ which lies, measured in the lateral direction y, with a first lateral center-of-gravity spacing a_{SPn} from the movement plane E_{B} of the work tool 2. In particular, the lateral handle spacing ag is at least 1.25 times, in particular at least 1.5 times, and in the embodiment shown approximately 1.59 times, the first lateral center-of-gravity spacing a_{SPn}.

When the battery packs 8, 9 are inserted, that is, as illustrated in the drawings, the battery-powered chainsaw has a gross center of gravity SP_{b} which lies in the lateral direction y with a second lateral center-of-gravity spacing a_{SPb} from the movement plane E_{B} of the work tool 2. In the case of the inserted battery packs 8, 9 according to the illustration in FIG. 2, the lateral handle spacing ag is in particular at least 1.15 times, in particular at least 1.3 times, and in the embodiment shown approximately 1.40 times, the second lateral center-of-gravity spacing aSPb.

In the case of tasks or sawing or cutting which are performed vertically, in which the movement plane E_{B} lies parallel to the direction of the weight force, during normal operation a reaction force acts on the work tool 2 upward in the vertical direction z, that is, toward the viewer in FIG. 2. The user must apply a corresponding counter-force on the rear handle 3. A notional line of engagement 20 which is marked in FIG. 2 can be laid through an imaginary point of application of the reaction force at the work tool 2 and also through the approximate center of the rear handle 3, that is, through the point at which the force of the hand is applied. In order to relieve the load on the user at the rear handle 3, the aim of the disclosure is to keep any torque acting around the line of engagement 20 as small as possible. The weight force applied at the net center of gravity SPₙ and in particular at the gross center of gravity SP_{b} also acts parallel to the movement plane E_{B} and consequently generates a weight force torque acting about the line of engagement 20. Because of the large lateral handle spacing ag according to the disclosure, the line of engagement 20 moves close to the net center of gravity SPₙ and in particular close to the gross center of gravity SP_{b}. The weight forces applied there have such a small spacing and consequently such a small lever arm relative to the line of engagement 20 that the resulting weight force torques are low and that consequently the user does not have to apply any corresponding counter-torque at the rear handle 3 via manual force. The load on the user is relieved and the battery-powered chainsaw or the battery-powered angle grinder can be maintained during operation more precisely in the movement plane E_{B} at which it has been set.

It can also be seen in the illustration according to FIG. 2 that the rear handle 3 lies, measured in the lateral direction y, between the battery receptacle center point P_{A} and the lateral handle section 5. This is important especially in the case of tasks or sawing which are performed horizontally, where the battery-powered chainsaw is held and guided at the rear handle 3 with one hand and at the lateral handle section 5 of the front bale handle 4 with the other hand. The direction of the weight force here corresponds to the lateral direction y. By virtue of its positioning according to the disclosure, the rear handle 3 lies relatively high and close to the lateral handle section 5 in the lateral direction y. In other words, it lies only slightly below the lateral handle section in the direction of the weight force. This makes it easier for the user to carry and guide the work apparatus with both hands in the case of horizontally performed tasks because they need to compensate only small height differences with their two hands.

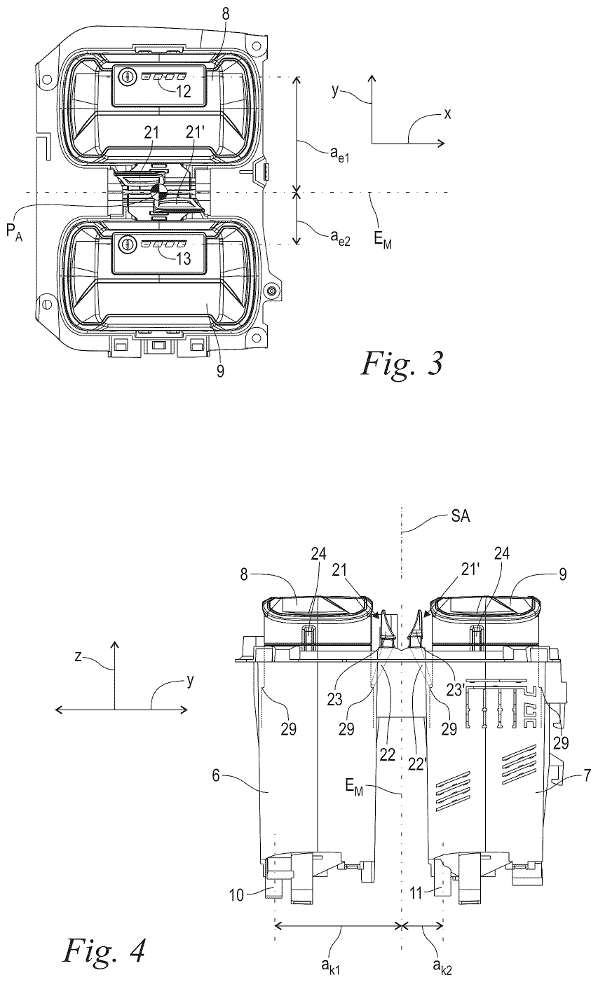

FIG. 3 shows an enlarged detailed illustration of the battery area of the battery-powered chainsaw in the plan view according to FIG. 1 with inserted battery packs 8, 9. The two battery packs 8, 9 are configured identically and have in each case one HMI element 12, 13 (HMI=human-machine interface). In the present case, the HMI elements 12, 13 are combinations of an illuminable bar display and a push button via which the charging state of the respective battery pack 8, 9 can be queried by the user. Different configurations of HMI elements 12, 13 can, however, also be provided with additional and/or different functions.

FIG. 4 shows a view from the rear of individual components of the two battery receptacles 6, 7 of the battery-powered chainsaw according to FIGS. 1 to 3 with battery packs 8, 9 inserted from above and locked. The two battery receptacles 6, 7 are provided with in each case one electrical contact 10, 11 into which appropriate contacts of the battery packs 8, 9 engage and via which an electrical connection is produced between the battery-powered chainsaw and the battery packs 8, 9 inserted in each case.

It can be seen from viewing FIGS. 3 and 4 together that the battery receptacles 6, 7 have a notional central plane E_{M} between them which extends in the longitudinal direction x and in the vertical direction z. The battery receptacles 6, 7 are configured in such a way that, in the inserted state of the battery packs 8, 9, a first element spacing a_{E1} of the first HMI element 12 of the first battery pack 8 from the notional central plane E_{M} and a second element spacing a_{E2} of the corresponding second HMI element 13 of the second battery pack 9 from the notional central plane E_{M} are not the same.

Analogously, the same also applies for the electrical contacts 10, 11: a first contact spacing a_{K1} of the first electrical contact 10 of the first battery receptacle 6 from the notional central plane E_{M} and a second contact spacing a_{K2} of the second electrical contact 11 of the second battery receptacle 7 from the notional central plane E_{M} are not the same.

In both cases, the differences between the spacings are selected in such a way that, in the plan view from above corresponding to the illustration according to FIG. 3, the two battery packs 8, 9 are not point symmetrical with respect to the battery receptacle center point P_{A} and instead are inserted and used next to each other in the same direction.

It can be seen in the plan view according to FIG. 2 that the housing 1 is wider to the left of the first battery receptacle 6 than to the right of the second battery receptacle 7. In conjunction with also viewing FIGS. 3 and 4 together, it is apparent that the central plane E_{M} is not identical to a notional central plane, lying parallel thereto but not marked here, of the housing 1. Rather, the central plane of the housing 1 lies to the left of the central plane E_{B} of the battery receptacles 6, 7. In the present case, this serves to supply space for an air filter (not illustrated) on the left-hand side, that is, on the side facing away from the work tool 2. In contrast, further apparatus components with a relatively high mass are situated more on the right-hand side facing the work tool 2. This also contributes to the net center of gravity SPₙ and in particular the gross center of gravity SP_{b} coming to lie close to the line of engagement 20.

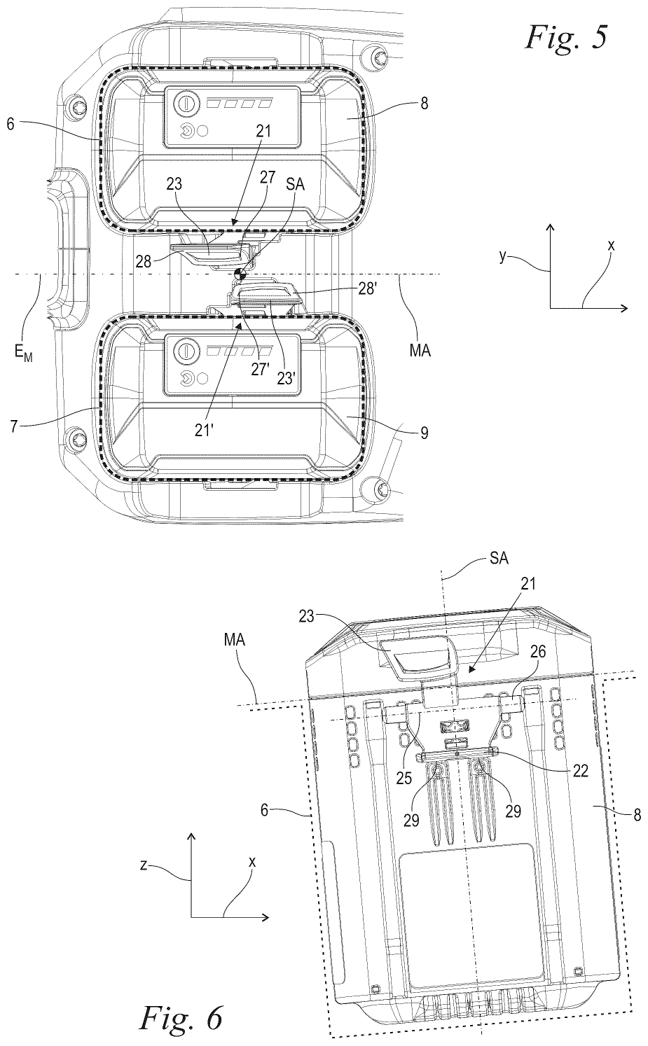

FIG. 5 shows an enlarged plan view of the battery area of the battery-powered chainsaw according to FIG. 1 with details of the arrangement of the battery locks 21, 21′. It can be seen that each of the two battery receptacles 6, 7 is associated in each case with a battery lock 21, 21′. The battery lock 21 prevents a battery pack 8 inserted into the battery receptacle 6 from falling out accidentally. Analogously, the battery lock 21′ prevents a battery pack 9 inserted into the battery receptacle 7 from falling out accidentally.

The two battery receptacles 6, 7 are arranged adjacent to each other. In the embodiment shown, they are laterally adjacent to each other in the lateral direction y. The two battery locks 21, 21′ are positioned between the two battery receptacles 6, 7. A notional center axis MA which lies within the central plane E_{M} already mentioned above runs between the battery receptacles 6, 7. The two battery receptacles 6, 7 can have an offset with respect to each other in the direction of the center axis MA. In other words, one of the two battery receptacles 6, 7 can be positioned further in front of or behind the in each case other battery receptacle 7, 6. In the present case, they are arranged opposite each other in the lateral direction y lying at right angles to the center axis MA and thus lie in the in the same position in the direction of the center axis MA.

FIG. 6 shows a side view of a battery pack 8 inserted into the schematically indicated battery receptacle 6 and a battery lock 21 engaging therewith and illustrated as a detached individual part. The description here also applies analogously for the further battery pack 9, inserted into the battery receptacle 7, with the associated battery lock 21′. The plane of the drawing in FIG. 6 lies parallel to the central plane E_{M}. When viewing FIGS. 4, 5, and 6 together, the position of an axis of symmetry SA for the two battery locks 21, 21′ and the position of the center axis MA can be seen. In the optional embodiment shown here, the axis of symmetry SA lies within the central plane E_{M} and stands at right angles to both the center axis MA and the lateral direction y. The axis of symmetry SA moreover runs, likewise optionally, through the battery receptacle center point P_{A} (FIG. 3). The axis of symmetry SA can lie parallel to the vertical axis z. It is apparent in particular in FIG. 6 that in the present case the axis of symmetry SA is tilted slightly backward relative to the vertical axis z and encloses an acute angle of ≤10° with the vertical axis z. Other angles can also be expedient. The same applies for the position of the center axis MA relative to the longitudinal direction x. The axis of symmetry SA runs within the central plane E_{M} considered parallel to an insertion direction (not illustrated in the drawings) of the battery packs 8, 9 into the associated battery receptacles 6, 7. The battery receptacles 6, 7 are here configured in such a way that the two battery packs 8, 9 are inserted not exactly counter to the vertical direction z, that is, not exactly from above, and instead slightly obliquely from the upper rear forward and downward.

With reference in particular to FIG. 6, the battery lock 21 includes a locking part 22 and an actuating part 23. The battery lock 21 is configured as a pivotable locking lever with a journal 26 between the locking part 22 and the actuating part 23, wherein the locking part 22 is arranged centrally with respect to the associated battery receptacle 6 in the direction of the center axis MA, and wherein the locking part 22 here also covers the axis of symmetry SA centrally. The actuating part 23 in contrast is positioned off-center thereto and offset with respect to the associated locking part 22 in the direction of the center axis MA, as is described in detail below.

The pivotable locking lever is mounted pivotably on the housing 1 via the journal 26, wherein the journal specifies a pivot axis 25 running parallel to the center axis MA. The battery pack 8 has at least at one of its side faces a locking catch 29 which bears against the locking part 22 in the inserted state of the battery pack 8 and consequently maintains the battery pack 8 in its inserted position. As a result of manual pressure, for example with a finger, on the actuating part, the locking lever executes a pivoting movement about the pivot axis 25 as a consequence of which the locking part 22 frees the locking catch 29 of the battery pack 8 such that the battery pack 8 can be removed upward from the battery receptacle 6. Here too the same applies analogously for the further battery receptacle 7, the associated battery pack 9, and the associated battery lock 21′ with its locking part 22′ and its actuating part 23′.

With reference in particular to FIG. 5, it can be seen that the actuating parts 23, 23′ of the battery locks 21, 21′ are arranged offset with respect to each other in the direction of the center axis MA, and that they thus lie in different positions in the direction of the center axis MA. As a result, it is achieved that, even in the case of a small spacing between the battery receptacles 6, 7, in each case one actuating part 23, 23′ can be actuated manually without interference from the in each case other actuating part 23, 23′.

The two battery locks 21, 21′ are configured as identical parts. It can be seen in particular in FIG. 5 that the two battery locks 21, 21′ are arranged point symmetrically, that is, rotated by 180° relative to each other, with respect to the axis of symmetry SA lying at right angles to the center axis MA and at right angles to the lateral direction y. The actuating parts 23, 23′ of the two battery locks 21, 21′ have in each case first actuating sections 27, 27′ and second actuating sections 28, 28′. The two actuating parts 23, 23′ are shaped and arranged in such a way that the respective first actuating sections 27, 27′ of the two actuating parts 23, 23′ are situated opposite each other with respect to the center axis MA in the lateral direction y. As a result, the two battery locks 21, 21′ can be actuated manually at the same time by the user pressing at the same time on the two opposite first actuating sections 27, 27′, for example with a finger. The two actuating parts 23, 23′ are moreover shaped and arranged in such a way that no part of the in each case other actuating part 23′, 23 is situated opposite the second actuating sections 28, 28′ of the two actuating parts 23, 23′ with respect to the center axis MA. As a result, the battery locks 21, 21′ can be actuated manually individually and independently of each other by the user pressing on the respective second actuating section 28, 28′ of the desired actuating part 23, 23′, for example with a finger, without thus clashing with the in each case other actuating part 23′, 23.

It is further apparent from viewing FIGS. 3, 4 together that the two battery receptacles 6, 7 are configured for a position of the two inserted battery packs 8, 9 in the same direction. The two battery packs 8, 9 have guide projections 24 which enable insertion in only one specific rotated position. A position in the same direction here means that certain characteristic features such as, for example, the HMI elements 12, 13 face the same side, in this case the left-hand side of the apparatus. In order to enable this in conjunction with the central position of the battery locks 21 between the two battery receptacles 6, 7, the battery packs 8, 9 have in each case a locking catch 29 on their two opposite side faces, as indicated schematically in FIG. 4. In this way, the locking parts 22, 22′ of the two battery locks 21, 21′ can come to bear against in each case one locking catch 29 of the two battery packs 8, 9 and effect the desired positional stability.

It is understood that the foregoing description is that of the preferred embodiments of the invention and that various changes and modifications may be made thereto without departing from the spirit and scope of the invention as defined in the appended claims.

1. A battery-powered chainsaw or a battery-powered angle grinder comprising:
a housing having a rear end;
a drive motor;
a work tool configured to be driven by said drive motor within a movement plane;
two battery receptacles, each configured to receive a battery pack for supplying said drive motor with electrical energy;
said work tool being arranged at a front end of said housing;
a rear handle arranged at said rear end of said housing;
the battery-powered chainsaw or battery-powered angle grinder defining a lateral direction running at right angles to said movement plane of said work tool;
said two battery receptacles lying next to each other in said lateral direction and enclosing between them a battery receptacle center point;
said battery receptacle center point lying, measured in said lateral direction, with a lateral center-point spacing from said movement plane of said work tool;
said rear handle lying, measured in said lateral direction, with a lateral handle spacing from said movement plane of said work tool; and,
said lateral handle spacing being greater than said lateral center-point spacing.

2. The battery-powered chainsaw or battery-powered angle grinder of claim 1, wherein said lateral handle spacing is at least 5% greater than said lateral center-point spacing.

3. The battery-powered chainsaw or battery-powered angle grinder of claim 1, wherein said lateral handle spacing is at least 10% greater than said lateral center-point spacing.

4. The battery-powered chainsaw or battery-powered angle grinder of claim 1, wherein the battery-powered chainsaw or the battery-powered angle grinder has a net center of gravity when no battery packs are inserted which lies in said lateral direction with a first lateral center-of-gravity spacing from said movement plane of said work tool; and, said lateral handle spacing is at least 1.25 times said first lateral center-of-gravity spacing.

5. The battery-powered chainsaw or battery-powered angle grinder of claim 4, wherein said lateral handle spacing is at least 1.5 times said first lateral center-of-gravity spacing.

6. The battery-powered chainsaw or battery-powered angle grinder of claim 1, wherein the battery-powered chainsaw or the battery-powered angle grinder has a gross center of gravity when the battery packs are inserted which lies in said lateral direction with a second lateral center-of-gravity spacing from said movement plane of said work tool; and, said lateral handle spacing is at least 1.15 times the second lateral center-of-gravity spacing.

7. The battery-powered chainsaw or battery-powered angle grinder of claim 6, wherein said lateral handle spacing is at least 1.3 times the second lateral center-of-gravity spacing.

8. The battery-powered chainsaw or battery-powered angle grinder of claim 1 further comprising a front bale handle having a lateral handle section; and, said rear handle lies, measured in said lateral direction, between said battery receptacle center point and said lateral handle section.

9. The battery-powered chainsaw or battery-powered angle grinder of claim 1, wherein said two battery receptacles include a first battery receptacle and a second battery receptacle and have a notional central plane between said first battery receptacle and said second battery receptacle; said two battery receptacles each have an electrical contact for electrically connecting the corresponding battery pack to the battery-powered chainsaw or the battery-powered angle grinder; and, a first contact spacing of said first electrical contact of said first battery receptacle from the notional central plane and a second contact spacing of said second electrical contact of said second battery receptacle from said notional central plane are not the same.

10. The battery-powered chainsaw or battery-powered angle grinder of claim 1, wherein said two battery receptacles have a notional central plane between them; the battery packs include a first battery pack having a first HMI element and a second battery pack having a second HMI element; said two battery receptacles are configured such that, in an inserted state of the battery packs, a first element spacing of the first HMI element of the first battery pack from said notional central plane and a second element spacing of a second HMI element of the second battery pack from said notional central plane are not the same.

11. A handheld battery-powered work apparatus comprising:
a housing;
a drive motor;
a work tool configured to be driven by said drive motor;
two battery receptacles, each of said two receptacles being configured to receive a battery pack for supplying said drive motor with electrical energy;
two battery locks;
each of said two battery receptacles being associated with one of the two battery locks for locking the corresponding battery pack in a corresponding one of the two battery receptacles;
said two battery receptacles being arranged adjacent to each other;
said two battery locks being positioned between said two battery receptacles;
each of said two battery locks having a locking part and an actuating part;
wherein a notional center axis runs between said two battery receptacles; and,
said actuating parts of said two battery locks are arranged offset with respect to each other in a direction of the notional center axis.

12. The handheld battery-powered work apparatus of claim 11, wherein said two battery receptacles are arranged opposite each other with respect to the notional center axis.

13. The handheld battery-powered work apparatus of claim 11, wherein said locking parts are arranged centrally with respect to a corresponding one of said two battery receptacles in a direction of the notional center axis.

14. The handheld battery-powered work apparatus of claim 11, wherein said actuating parts of said two battery locks are arranged offset with respect to associated ones of said locking parts in the direction of the notional center axis.
